(19) United States
(12) Patent Application Publication
(10) Pub. No.: US 2005/0020442 A1
(43) Pub. Date: Jan. 27, 2005

(54) Doped alumina catalysts

(76) Inventors: Paul Sermon, Surrey (GB); Patrick Forrest, Middlesex (GB)

Correspondence Address: FAY KAPLUN & MARCIN, LLP, 15O BROADWAY, SUITE 702, NEW YORK, NY, 10038, US

(21) Appl. No.: 10/482,615

(22) PCT Filed: Jun. 21, 2002
(86) PCT No.: PCT/GB02/02856

(30) Foreign Application Priority Data
Jun. 28, 2001 (GB) 0115729.6

(51) Int. Cl. B01J 23/10

(52) U.S. Cl. 502/304

(57) ABSTRACT

Described is a catalyst for the removal of pollutants from the exhaust gases of automotive internal combustion engines wherein the catalyst is alumina doped with cations of two groups of metals M and M′ being present in a quantity in the range 10 to 25% by weight of the catalyst and the weight ratio of M:M′ lies in the range 0.5-2.0.

This invention relates to doped alumina catalysts; that is to say catalysts principally comprising alumina (Al₂O₃) and certain additives. It is particularly concerned with such catalysts for use in the removal of pollutants from the exhaust gases of automotive internal combustion engines.

Catalysts used for treatment of automotive exhaust gases to remove carbon monoxide, hydrocarbons and oxides of nitrogen (NOₓ) are often termed three-way catalysts (TWCs). The efficiency with which they achieve the removal is affected by such factors as the prevailing temperature (T) and the air:fuel ratio (λ). They need to operate over a range of temperatures in order to commence operation quickly after a cold start, and also to operate effectively at sustained high temperatures. These high temperatures may result from the catalyst's proximity to the engine and/or to a strongly exothermic reaction taking place on the catalyst. Similarly the catalysts need to operate over a reasonably wide range of air:fuel ratios.

Alumina is attractive as a TWC component because of its low cost, good interaction with precursors of other TWC components, its high surface area and its stability to temperatures in excess of 1100° K. It may be applied as boehmite (AlOOH), which then converts to the thermodynamically stable α-phase of Al₂O₃.

Doping of the alumina with certain metal cations of variable or fixed oxidation state has been widely proposed with a view to providing improved thermal stability, hardness and reactivity over alumina alone. Metals employed as such dopants include cerium (Ce³⁺/Ce⁴⁺) and barium (Ba²⁺). One or more platinum group metals (referred to herein as PGMs) when supported on Al₂O₃ promote conversion of the exhaust stream pollutants; for example oxidation of CO and hydrocarbons mostly under oxygen-rich conditions or reduction-decomposition of NOₓ mostly under oxygen-lean conditions.

Ceria (CeO₂) is a well-established alumina dopant, typically used in a quantity of up to 20% by weight of the catalyst. At lower proportions (e.g. <1%) and elevated temperatures (e.g. >1200° K) CeAlO₃ can be formed, but at higher ceria contents the Al₂O₃ and CeO₂ tend to segregate at the Al₂O₃ surface. Ceria can take up and release oxygen reversibly and so is said to have an oxygen storage capacity (OSC) that can assist CO and hydrocarbon oxidation under oxygen-lean conditions.

Other materials suggested as oxidation exhaust catalysts include lanthanum cobaltite (LaCoO₃) and barium cerate (BaCeO₃), the latter being a proton-conducting perovskite (with each Ba²⁺ surrounded by eight CeO₆ octahedra).

Improvements in three-way catalysts have been achieved in part by combinations of different dopants. Thus the oxygen storage capacity (OSC) of ceria is enhanced by interaction with any PGMs present. Ceria has also been found to modify ZrO₂ and its CO and propene oxidation activity, with the result that CeO₂—Al₂O₃ and CeO₂—ZrO₂ have been extensively used in automotive exhaust catalysts. Tb₄O₇ improves the OSC of CeO₂, even though the surface area (45 m²/g) can be modest.

Incorporation of ions such as La³⁺ increases the stability of the alumina at high temperatures. BaO has been added to alumina, for example by conventional, micro-emulsion and sol-gel methods, leading ultimately to hexa-aluminate (BHA; BaAl₁₂O₁₉). Alumina has also been simultaneously doped with BaO and CeO₂ [Angrove et al, Appl. Catal. 194-5A,27,(2000)] with analysis of the phases developed.

PGMs commonly used in TWCs have been palladium, platinum and rhodium, typically in concentrations of 0.3 to 1.2 g/dm³ (kg/m³). A three way catalyst could thus be Pt—Rh/CeO₂—Al₂O₃. Wang et al [Solid State Ionics 111,333,(1998)] and Dunn et al [Solid State Ionics 128,141, (2000)] report the insertion of metal cations into tetrahedral and/or octahedral sites in the O²⁻ array in XAl₂O₄, XAl₁₂O₁₉ and X-β-Al₂O₃.

U.S. Pat. Nos. 5,939,354 and 5,977,017 of S J Golden relate to certain perovskite-type catalysts with three-way activity for the removal of pollutants from exhaust gases of internal combustion engines and from industrial waste gases. The catalysts are represented by the general formula Aₐ₋ₓBₓMO_{b}, in which A is a mixture of elements originally in the form of a defined mixed lanthanide; B is a divalent or monovalent cation; M is at least one element selected from the group consisting of elements having an atomic number of 22 to 30, 40 to 51, and 73 to 80; a is 1 or 2; b is 6 or 4 when a is respectively 1 or 2; and 0≦x<7.

The catalytic activity of perovskites has also been addressed by Jovanovic et al (Three-Way Activity and Sulphur Tolerance of Single Phase Perovskites; CAPOC II; 1991, page 391 et seq.) and Mathieu-Deremince et al (Structure and Catalytic Activity of Mixed Oxides of Perovskite Structure; CAPOC III; 1995, page 393 et seq.).

Traditionally the catalysts for automotive exhaust treatment have been applied to a substrate material, for example by wash-coating. Suitable substrate materials include certain ceramics, for example cordierite (2MgO.Al₂O₃.5SiO₂), and certain metals, for example stainless steel, Fecralloy™ and titanium.

Concern may at some time arise over the implications of PGM emissions from automotive catalysts and over the poisoning effect on the platinum group metals of materials such as lead, sulphur and phosphorus derived from the fuel. In part as a result of these concerns attempts have been made to produce non-PGM catalysts for use in emission control from automobile exhausts albeit that these non-PGM catalysts often have modest surface area. The aim has been to provide non-PGM catalysts that would not be poisoned by metals in the exhaust gas stream, for example by metals such as lead, manganese, sodium or potassium which derive from gasoline, or by metals such as zinc derived from lubricating oil, or by other poisons such as sulphur or phosphorus. While it has been found that the activity of non-PGM catalysts increases with pollutant contact time [L. S.Yao [React.Kin.Catal.Lett. 56,283,(1995)] no such catalyst has hitherto been developed that is sufficiently efficient.

The present invention accordingly has the object of producing non-PGM automotive exhaust catalysts with efficiencies close to those having a PGM content.

According to the invention there is provided a catalyst for the removal of pollutants from the exhaust gases of automotive internal combustion engines which comprises alumina doped with cations of other metals, characterised in that the dopants comprise cations of two groups of metals M and M′ wherein M and M′ are:
(a) monovalent M (e.g. K⁺) and pentavalent M′ (e.g. Ta⁵⁺) or,
(b) divalent M (e.g. Ba²⁺) and quadravalent M′ (e.g. Ce⁴⁺) or,
(c) divalent M (e.g. Ba²⁺) and a combination of divalent and pentavalent M′ (e.g. Co²⁺ and Ta⁵⁺) or,
(d) divalent M (e.g. Ba²⁺) and a combination of trivalent and pentavalent M′ (e.g. Ce³⁺ and Nb⁵⁺) or,
(e) divalent M (e.g. Ba²⁺) and a combination of divalent and hexavalent M′ (e.g. Ba²⁺ and Re⁶⁺) or,
(f) trivalent M (e.g. Ce³⁺) and trivalent M′ (e.g. Fe³⁺) or,
(g) trivalent M (e.g. La³⁺) and a combination of divalent and quadravalent M′ (e.g. Co²⁺ and Ir⁴⁺)
   and wherein M and M′ are both present in a quantity in the range 10 to 25% by weight of the catalyst and the weight ratio of M:M′ lies in the range 0.5-2.0. M and M′ may be selected from those illustrated by F. S. Galasso in ‘Structure, Properties and Preparation of Perovskite-type Compounds’ (Pergamon Press, 1969) and give alumina-dispersed MM′O_{z} (where z is variable around a value of 3).

A doped alumina catalyst according to the invention is described herein as a “pairwise-doped alumina”. This catalyst can be prepared as a composite or homogenous phase by sol-gel routes as further described below to give a “sol-gel pairwise-doped alumina” (SPA). The primary beneficial effect of the M dopants lies in promoting CO oxidation but these also assist in promoting hydrocarbon oxidation. In contrast, the primary beneficial effect of the M′ dopants lies in promoting hydrocarbon oxidation but these also assist in promoting CO oxidation. The combined use of both dopants provides a synergistic improvement over either type of dopant used alone, to the extent of meeting the objective of achieving pollutant removal efficiencies comparable with catalysts having a PGM content.

The oxygen content of the catalysts according to the invention varies according to the prevailing air:fuel ratio, temperature and time. Their lead content varies with the nature and levels of lead in the fuel, the stream composition, time and the prevailing temperature (especially since they will operate at higher temperatures than PGM-catalysts). This higher temperature lowers the level of lead uptake.

Another specific advantage of catalysts according to the invention is that they have good thermal stability, thereby permitting their use as close-coupled catalysts.

A further advantage of the catalysts is that they have strong resistance to poisoning by lead, manganese, sodium or potassium from gasoline, or by zinc from lubricating oil, or by other poisons such as sulphur or phosphorus. In terms of the effect upon the catalyst of the invention Pb—PbOₓ is not a simple poison and indeed the PbOₓ is at times a promoter rather than a poison. These Pb—PbOₓ and PbOₓ materials enter and leave the catalyst without long-term damage to its activity.

Thus unlike PGM catalysts, the materials of the invention are not destroyed by lead introduced from the fuel, nor do they emit PGMs during use. The catalysts are therefore of special benefit in markets where the lead content of gasoline is high enough to have a detrimental effect on a catalyst over its useful life. Even a lead content of 5 mg/dm³ has been found to have a noticeably harmful effect on conventional Pt:Rh TWCs. It is therefore common practice for automotive manufacturers to increase the PGM loading to ensure that the required durability criteria are met.

Emission standards for vehicles in developed countries are becoming increasingly demanding, with the effect that even a small degree of poisoning or inhibition of a catalyst by trace elements present in the gasoline or lubricating oils is quite undesirable. There is also a trend for the relevant government agencies to increase the minimum life span over which a catalyst must remain effective, and some legislation now requires a catalytic converter fitted to a new vehicle to keep within official emission limits for 150,000 miles. In order to meet these expectations of lower emission levels coupled with increased durability, there is a perceived need either completely to eliminate known poisons from gasolines and lubricating oils, or alternatively to find new types of catalysts that are not susceptible to poisoning.

Another growing trend in emission control is to address the problem of emissions from small engines, such as those fitted to motorcycles, construction equipment and garden machinery. These engines present a two-fold problem for conventional PGM catalysts. Firstly, they tend to have relatively high levels of engine-out emissions. Secondly, the length of their exhaust systems is short. The combination of these two factors means that the catalyst is exposed to very high temperatures (resulting from the exhaust temperature on entering the catalyst zone and the heat generated by exothermic reactions on ihe catalyst). The high temperatures induce a variety of undesirable effects in conventional PGM catalysts. The most common of these is sintering, and others include loss of surface area and changed interactions between the PGMs and the catalyst. Carol et al (High Temperature Deactivation of Three-Way Catalyst; Soc. of Automotive Engineers; paper 892040) found that ageing a Pt:Rh TWC for 48 hours at 1323° K reduced its conversion efficiency for hydrocarbons and CO by almost 50%.

Additionally there could at some time be concern about emissions of PGMs from catalysts.

The three most important advantages of the catalysts of the invention over a conventional PGM TWC are:
increased resistance to poisoning;
increased tolerance of high-temperature operation;
absence of PGM emissions to the atmosphere.

The dispersed MM′O_{z}, phase that is produced in these doped alumina catalysts can involve Pb, Zn, K, Na, etc as integral components. Hence these SPA materials are not poisoned by elements normally a problem for PGM-based TWCs.

Compared with simple perovskites (e.g. U.S. Pat. Nos. 5,939,354 and 5,977,017 describe perovskite samples of modest surface area [<13 m²/g]) the catalysts of the invention have a higher surface area. They are amorphous and readily wash-coated onto a variety of suitable supports. They contain no platinum group metals, unlike some perovskites which may be selected to contain Ru, Co, Ni and Pd. The use of some of these perovskites further causes specific concerns over nickel emissions, either as the metal or its compounds.

The invention further provides a method of preparing a three way catalyst for the removal of pollutants from the exhaust gases of automotive internal combustion engines which comprises forming a sol-gel of alumina doped with cations of other metals, in which the dopants comprise cations of two groups of metals M and M′ as defined above. In these sol-gels M and M′ are both present in a quantity in the range 10 to 25% by weight of the catalyst and the weight ratio of M:M′ lies in the range 0.5-2.0.

The sol-gels of the invention are typically opaque gels of variable viscosity. Sol-gel processing of the doped and undoped alumina is beneficial in yielding high surface areas, for example 140-150 m²/g after heating to 1273° K, and allowing uniform distribution of dopants such as BaO. A high available surface area is an especially desirable characteristic of automotive exhaust treatment catalysts. Having Ba²⁺ as M has the advantage of enhancing NOₓ, storage under oxygen-rich conditions, in addition to decomposing-reducing NOₓ.

The sol-gels incorporating catalysts according to the invention may be applied as a coating to a suitable substrate, for example by wash-coating, dip coating, spin coating or spray coating, either as single or multiple layers. The preferred substrates are monolithic ceramic or monolithic metallic materials. In one very useful embodiment of the invention the sol-gel is formed in situ on the substrate, thereby avoiding any need for a pre-coating step and generally facilitating—and thus reducing the cost of—the exhaust gas treatment system in which it is incorporated.

According to the method of the invention the sol-gel may conveniently be prepared by the following steps:
(a) a salt (e.g. a nitrate) of M and a salt (e.g. a nitrate) of M′ in a selected ratio and selected concentrations are dissolved in an organic complexing agent (e.g. a glycol of suitable OH-group separation), and the resulting solution is refluxed;
(b) as aluminium alkoxide is dissolved in a further quantity of the complexing agent used for M and M′ and this solution is also refluxed;
(c) the refluxed solutions of (a) and (b) are mixed and further refluxed;
(d) the mixed solution is diluted in a controlled manner by addition of a specified quantity of water and the refluxing is continued;
(e) the diluted mixed solution is aged in the presence or absence of a pore templating agent and is then either
   (i) diluted with alcohol (corresponding to the Al alkoxide used) to a suitable viscosity to provide a sol-gel suitable for coating on to a substrate; or
   (ii) dried (in vacuum, sub—or super-critically) and calcined to give a homogeneous material.

In a variation of the aforesaid sol-gel preparation procedure, sols of MOₓ and M′Oₓ sols may be introduced to the sol-gels at selected times through the procedure to give a less-homogeneous, partially-segregated material.

In an alternative embodiment of the invention, the sol-gel pairwise-doped alumina catalysts may be prepared in-situ on the substrate by organo-metallic chemical vapour deposition.

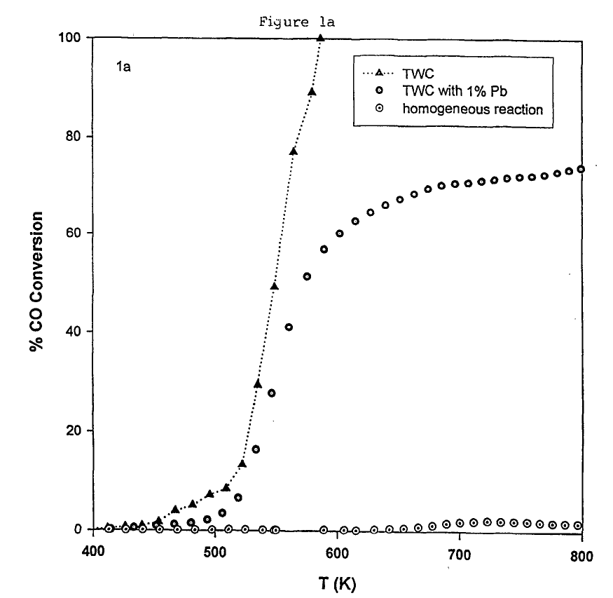

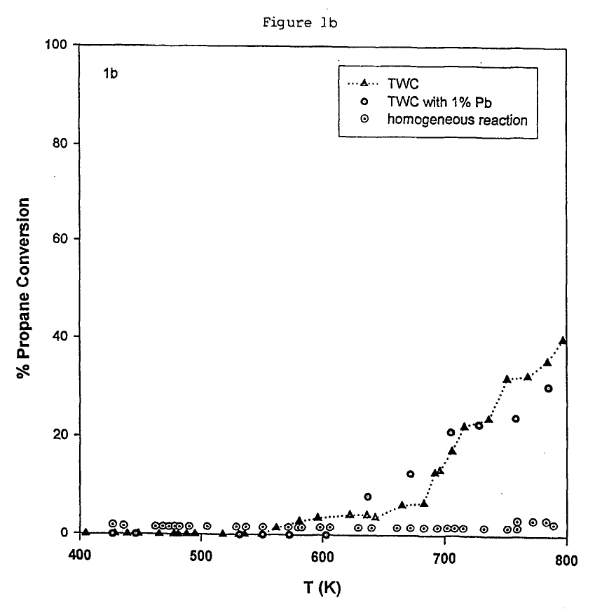

The invention is further described with reference to the following table and FIGS. 1 to 3.

FIG. 1 illustrates the activity of a commercial three way catalyst with and without 1% Pb—PbOₓ addition.

FIG. 1(a) shows the results for CO conversion.

FIG. 1(b) shows the results for C₃H₈ conversion. In both cases the air:fuel ratio (λ) was 1. Blank data for homogeneous oxidation reactions are given by open dotted circles; these reactions had very low rates.

FIG. 1 shows that a sample (200 mg) of a ground commercial Pd, Pt and Rh PGM-containing three way catalyst (TWC) on cordierite was active in CO and C₃H₈ oxidation when tested under stoichiometric conditions chosen to be standard (i.e. 6000 ppm CO, 1000 ppm NO, 520 ppm propane, 5800 ppm O₂, N₂ balance to 101 kPa, flowing at 60,000 h⁻¹). The temperatures required for 50% CO and C₃H₈ conversion [T_{1/2}(CO) and T_{1/2}(C₃H₈)] are 550° K and 855° K respectively. The addition of 1% Pb—PbOₓ suppressed CO oxidation, but (surprisingly) not C₃H₈ oxidation activity. The T_{1/2}(CO) and T_{1/2}(C₃H₈) values for the homogeneous reaction in the blank reactor were much higher (i.e. 940° K and 890° K respectively).

The table illustrates results for homogeneous samples prepared with M=Ce and M′=Ba. This shows that the total surface areas (e.g. 111-162 m²/g) of the samples after thermal treatment at 1173-1223° K were good, although the total surface areas did decrease as the total dopant concentration rose.

TABLE

| % M = Ba | % M′ = Ce | S_{BET} (m²/g) |
|---|---|---|
| 0 | 5 | 144 |
| 5 | 5 | 145 |
| 20 | 5 | 118 |
| 0 | 15 | 162 |
| 5 | 15 | 150 |
| 20 | 15 | 111 |

The M-M′ dopants used alone did not suppress the alumina surface area unduly.

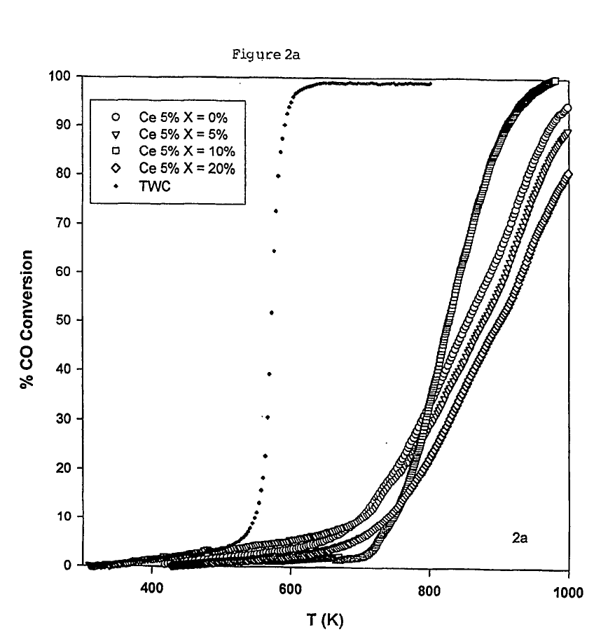

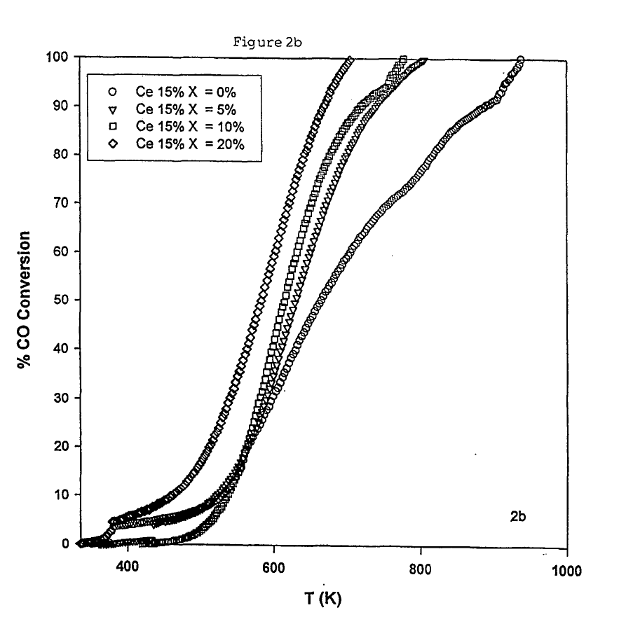

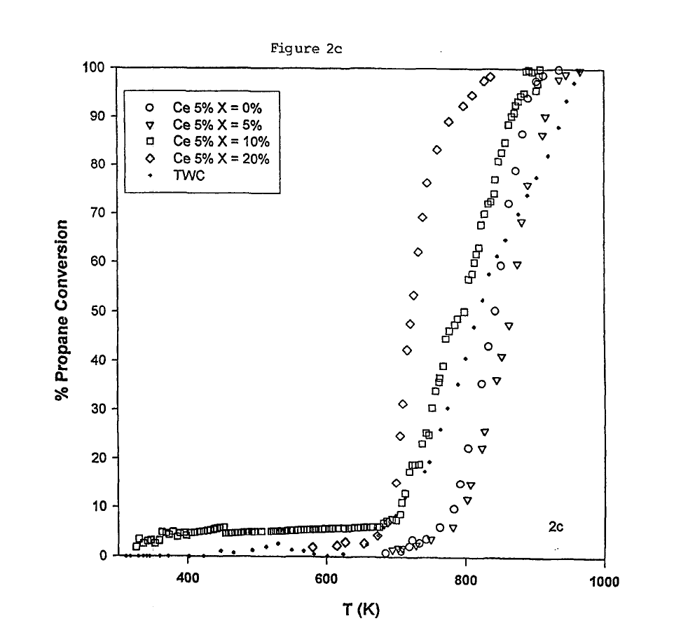

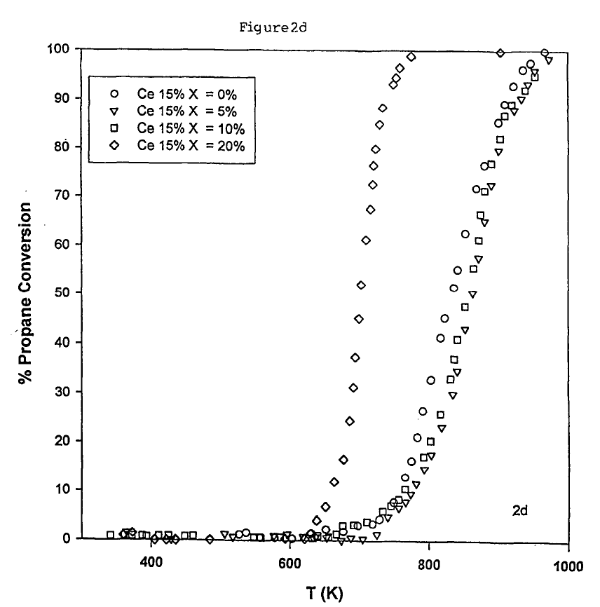

FIG. 2(a to d) illustrates oxidation of CO (a,b) and propane (c,d) over sol-gel exhaust catalysts with different Ce (M′) and Ba (M) levels.

Unsupported samples 200 mg) of sol-gel pairwise doped alumina (SPA) catalysts were tested for their potential as non-PGM TWC components in CO and propane (C₃H₈) oxidation (see FIG. 2) using the standard stoichiometric reactant stream mentioned above with reference to FIG. 1.

At 5% ceria, BaO addition produced poor CO oxidation activity relative to the TWC (see FIG. 2a), but at 15% ceria, BaO addition produced a good CO oxidation catalyst, with a lower T_{1/2}(CO) than the commercial TWC (see FIG. 2b). The best CO oxidation catalysts had about 20% CeO₂ and BaO, beyond this the surface area and activity of the SPA catalyst was suppressed. However, the best SPA sample had better low temperature activity than the TWC, although this moved to higher temperatures as the space velocity increased.

In C₃H₈ oxidation the addition of baria was shown to be more important than ceria. Again the overall propane oxidation activity of the best SPA sample was better than the commercial TWC: its T_{1/2}(C₃H₈) being lower than that of the PGM-TWC [e.g. 850° K in FIG. (1b)].

Raising the space velocity to 120,000 h⁻¹ over the non-PGM SPA materials raised their T_{1/2} (CO) and T_{1/2}(C₃H₈) values as it would for a PGM-based TWC. However, the lower cost of non-PGM SPA materials means there is less of an economic and environmental penalty in raising the catalyst loading or weight to maintain activity at higher space velocities. Similar trends to those seen in FIG. 2 were found for other hydrocarbons and at other λ ratios. SPA non-PGM oxide materials have by design a variable oxygen content and z value. It is this OSC property and their oxygen buffening capacities (OBC) which allows a broadening of the λ—window over which they operate.

The table also shows that the SPA catalysts of the invention compare well in terms of surface area with earlier doped aluminas (e.g. those described in the Angrove paper mentioned above) and perovskites (e.g. Golden's U.S. Pat. Nos. 5,939,354 and 5,977,017 mentioned above).

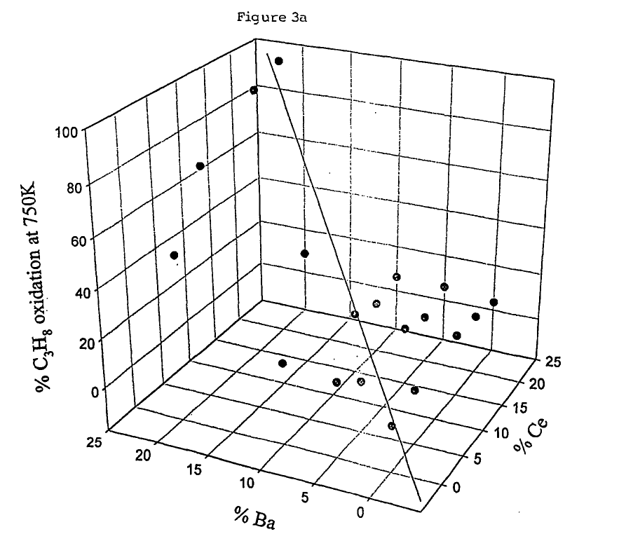

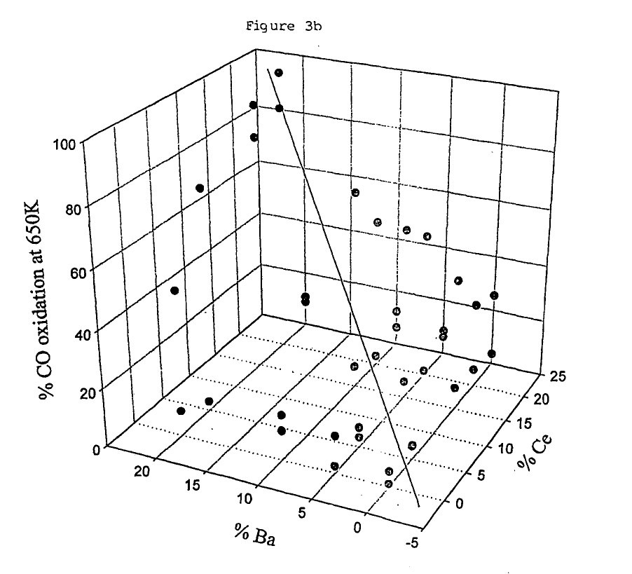

FIG. 3 shows the beneficial effects upon CO and C₃H₈ and propane oxidation activity of barium and cerium addition to sol-gel pairwise-doped alumina samples. Such catalysts also showed useful activity in NOₓ removal on Ba—Ce pair-wise doping.

1-10. (Cancelled).

11. A catalyst for a removal of pollutants from exhaust gases of an automotive internal combustion engine which comprises alumina doped with cations of other metals, wherein the dopants comprise cations of two groups of metals M and M′,
where M and M′ are one of:
(a) monovalent M and pentavalent M′,
(b) divalent M and quadravalent M′,
(c) divalent M and a combination of divalent and pentavalent M′,
(d) divalent M and a combination of trivalent and pentavalent M′,
(e) divalent M and a combination of divalent and hexavalent M′,
(f) trivalent M and trivalent M′, and
(g) trivalent M and a combination of divalent and quadravalent M′, and
wherein each of M and M′ is present in a quantity in a range of 10 to 25% by weight of the catalyst and the weight ratio of M:M′ lies in a range of 0.5 to 2.0.

12. A catalyst as claimed in claim 11, wherein in the form of a sol-gel of alumina doped with the said cations of other metals.

13. A catalyst as claimed in claim 12, wherein the alumina doped with the cations of other metals is in a homogenous phase in the sol-gel.

14. A catalyst as claimed in claim 11, wherein the weight ratio of M:M′ is substantially 1:1.

15. A catalyst as claimed in claim 12, wherein the weight ratio of M:M′ is substantially 1:1.

16. A catalyst as claimed in claim 13, wherein the weight ratio of M:M′ is substantially 1:1.

17. A catalyst as claimed in claim 11, wherein the catalyst is deposited on one of a monolithic ceramic and a metallic substrate.

18. A catalyst as claimed in claim 12, wherein deposited on one of a monolithic ceramic and metallic substrate.

19. A catalyst as claimed in claim 13, wherein the catalyst is deposited on one of a monolithic ceramic and a metallic substrate.

20. A method of preparing a catalyst for a removal of pollutants from the exhaust gases of automotive internal combustion engines, comprising the steps of:
forming a sol-gel of alumina doped with cations of other metals, the dopants comprising of cations of two groups of metals M and M′,
where M and M′ are one of:
(a) monovalent M and pentavalent M′,
(b) divalent M and quadravalent M′,
(c) divalent M and a combination of divalent and pentavalent M′,
(d) divalent M and a combination of trivalent and pentavalent M′,
(e) divalent M and a combination of divalent and hexavalent M′,
(f) trivalent M and trivalent M′, and
(g) trivalent M and a combination of divalent and quadravalent M′, and
wherein each of M and M′ is present in a quantity in a range of 10 to 25% by weight of the catalyst and the weight ratio of M:M′ lies in a range of 0.5 to 2.0.

21. A method as claimed in claim 20, wherein the sol-gel is formed in situ on a support substrate.

22. A method as claimed in claim 20, wherein the sol-gel is prepared by the following steps:
(a) a salt of M and a salt of M′ in a selected ratio and selected concentrations are dissolved in an organic complexing agent, and the resulting solution is refluxed;
(b) aluminium alkoxide is dissolved in a further quantity of the complexing agent used for M and M′ and this solution is also refluxed;
(c) the refluxed solutions of (a) and (b) are mixed and further refluxed;
(d) the mixed solution is diluted in a controlled manner by addition of a specified quantity of water and the refluxing is continued; and
(e) the diluted mixed solution is aged in the presence or absence of a pore templating agent and is then either (i) diluted with alcohol, corresponding to the Al alkoxide used, to a suitable viscosity to provide a sol-gel suitable for coating on to a substrate; or (ii) dried in vacuum, sub-or super-critically and calcined to give a homogeneous material.

23. A method as claimed in claim 21, wherein the sol-gel is prepared by the following steps:
(a) a salt of M and a salt of M′ in a selected ratio and selected concentrations are dissolved in an organic complexing agent, and the resulting solution is refluxed;
(b) aluminium alkoxide is dissolved in a further quantity of the complexing agent used for M and M′ and this solution is also refluxed;
(c) the refluxed solutions of (a) and (b) are mixed and further refluxed;
(d) the mixed solution is diluted in a controlled manner by addition of a specified quantity of water and the refluxing is continued; and
(e) the diluted mixed solution is aged in the presence or absence of a pore templating agent and is then either (i) diluted with alcohol, corresponding to the Al alkoxide used, to a suitable viscosity to provide a sol-gel suitable for coating on to a substrate; or (ii) dried in vacuum, sub-or super-critically and calcined to give a homogeneous material.

24. A method as claimed in claim 20, wherein sols of M Ox and M′ OX sols are introduced to the sol-gels at selected times through the procedure to give a less-homogeneous, partially-segregated material.

25. A method as claimed in claim 21, wherein sols of M Ox and M′ OX sols are introduced to the sol-gels at selected times through the procedure to give a less-homogeneous, partially-segregated material.

26. A method as claimed in claim 22, wherein sols of M Ox and M′ OX sols are introduced to the sol-gels at selected times through the procedure to give a less-homogeneous, partially-segregated material.

27. A method as claimed in claim 23, wherein sols of M Ox and M′ OX sols are introduced to the sol-gels at selected times through the procedure to give a less-homogeneous, partially-segregated material.

28. A method as claimed in claim 24, wherein sols of M Ox and M′ OX sols are introduced to the sol-gels at selected times through the procedure to give a less-homogeneous, partially-segregated material.

29. A method as claimed in claim 20, wherein the sol-gel is prepared in-situ on a substrate by organo-metallic chemical vapour deposition.
